(19) United States
(12) Patent Application Publication
(10) Pub. No.: US 2004/0111502 A1
(43) Pub. Date: Jun. 10, 2004

(54) Apparatus for adapting distribution of network events

(76) Inventor: Martin J Oates, Stowmarket (GB)

Correspondence Address: NIXON & VANDERHYE, PC, 1100 N GLEBE ROAD, 8TH FLOOR, ARLINGTON, VA, 22201-4714, US

(21) Appl. No.: 10/220,854

(22) PCT Filed: Mar. 28, 2001
(86) PCT No.: PCT/GB01/01391

(51) Int. Cl. G06F 15/173; G06F 13/12; G06F 13/10; G06F 9/44

(52) U.S. Cl. 709/223; 703/21

(57) ABSTRACT

This invention concerns a method of adapting distribution of network events between two networks in accordance with customer feedback in respect of the networks. The method includes modelling network behaviour for certain network traffic profiles, adapting network parameters for one of the networks, assessing customer reaction to the adapted and unmodified network, and modifying the distribution of traffic between the networks in accordance with the customer feedback.

The present invention relates to apparatus for adapting the distribution of network events between two or more networks.

Users of applications and devices that send and receive data over a network are directly affected by network performance. Thus network operators that manage their networks efficiently will attract a greater customer base than those that are less efficient at network management. For voice traffic, the speed at which a call is set up is dependent on many factors, including node capacity, routing mechanisms, network algorithms, network hardware performance etc. Users may experience unacceptable delays to call set up and/or unacceptable call quality, which in the case of a user representing a Corporate entity, may affect the success of their business.

In the vibrant Information Technology climate of today, many network operators compete for an ever-increasing volume of network traffic. It is therefore vital that network operators can offer and maintain a reliable network service if they are to retain their customers. A coupling between customer satisfaction and network performance is theoretically acknowledged, but there is little data to support any measurable correlations. Given the increasing loads on network devices, and the fact that switching devices remain a limiting factor in network equipment, it is thus important that variations in network configuration are explored in parallel with user expectations and profiles.

According to the present invention there is provided a network simulation method according to claim 1.

Advantageously, the customer response is derivable from parameters representative of customer expectations of any one, or all, of quality of service, network charging rates and network downtime.

Preferably the method includes creating a plurality of strings of values representative of the one or more network parameters and applying an adaption algorithm, such as a Genetic Algorithm thereto. The Genetic algorithm is applied a plurality of times in order to generate a plurality of groups of network parameters, and each group is applied to the first network. The performance of the first network is compared for each group in order to identify a group of network parameters that most closely resembles a target value.

Conveniently the network events are configured to occur during any one of a plurality of days, a single day, or a predetermined period in a day.

Advantageously the method can be applied to any number of networks. For example, if applied to three networks, the method could include a further step, wherein a second group of network parameters is adapted in accordance with different criteria to that applied to the first network, and the third network is operated in accordance with that adapted second group. Customer response to all three networks can then be evaluated and the distribution of network events allocated accordingly.

Further features of apparatus for adapting distribution of network events will be described, by way of example only as an embodiment of the present invention, and with reference to the accompanying drawings, in which:

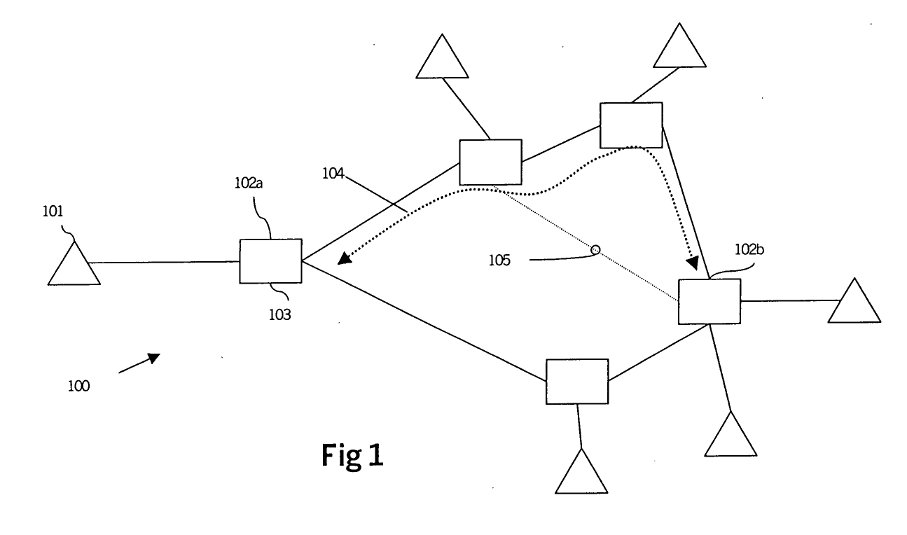

FIG. 1 is a schematic diagram of a Synchronous Digital Hierarchy network;

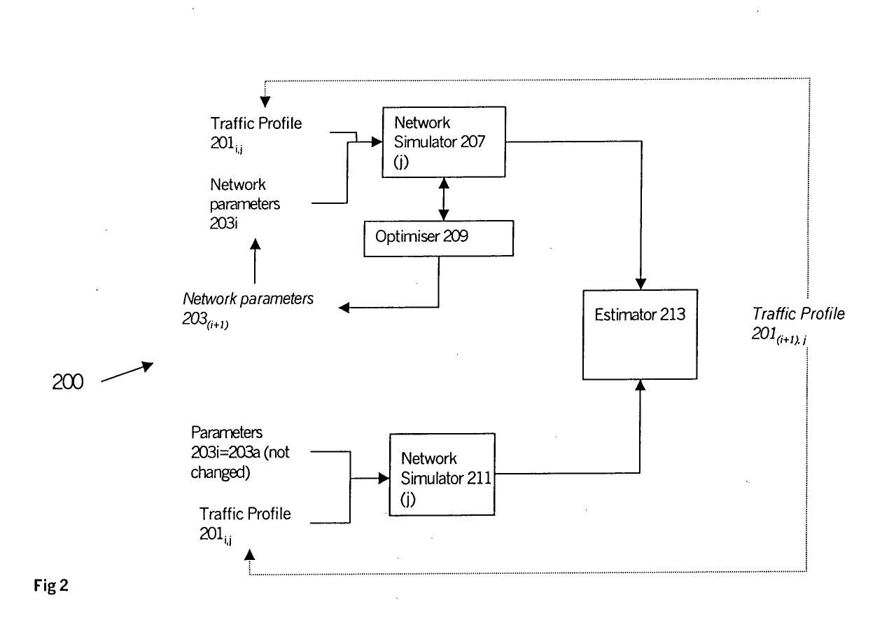

FIG. 2 is a schematic block diagram showing apparatus for optimising configuration parameters of a network according to the present invention;

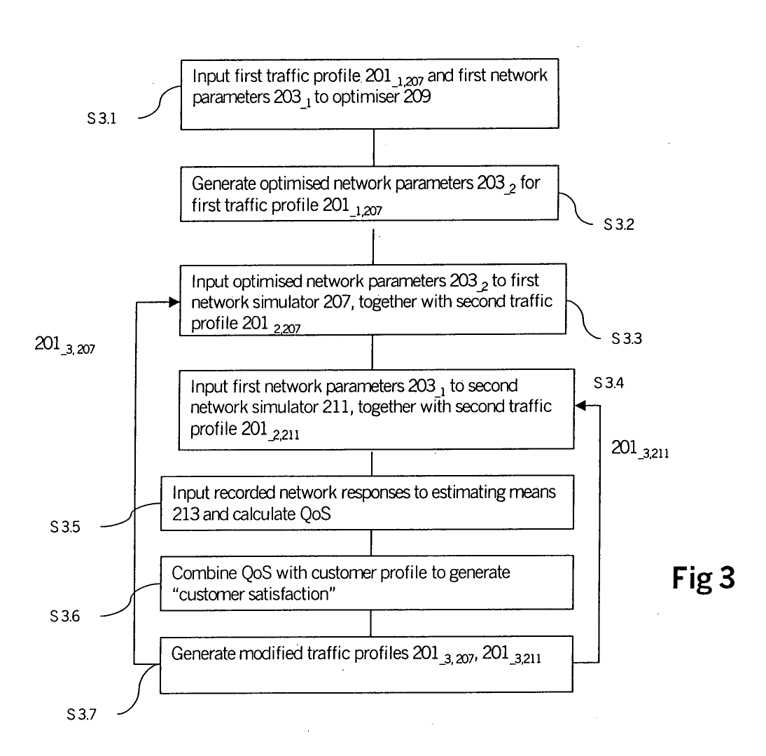

FIG. 3 is a flow diagram showing interaction between the apparatus of FIG. 2;

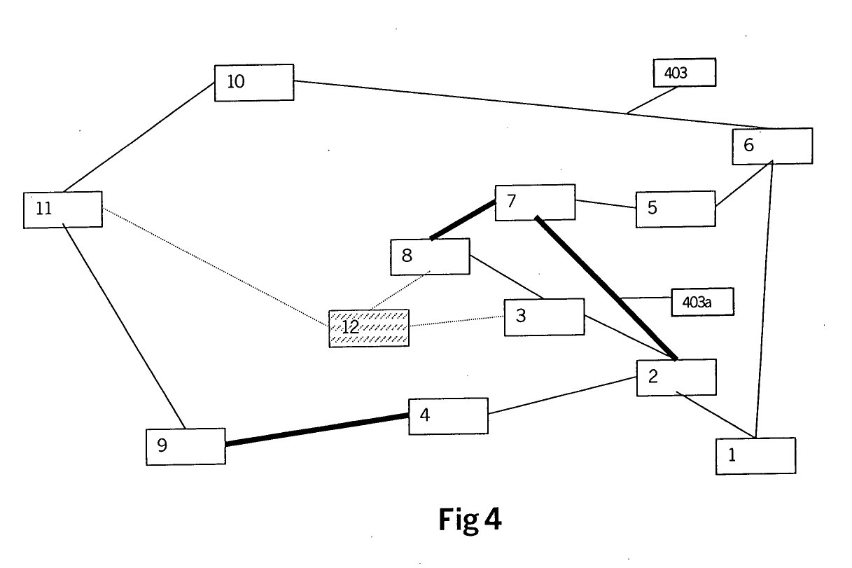

FIG. 4 is a schematic diagram of a network simulated by the network simulator comprising the apparatus of FIG. 2, including network nodes, inter-node link capacity and established circuits;

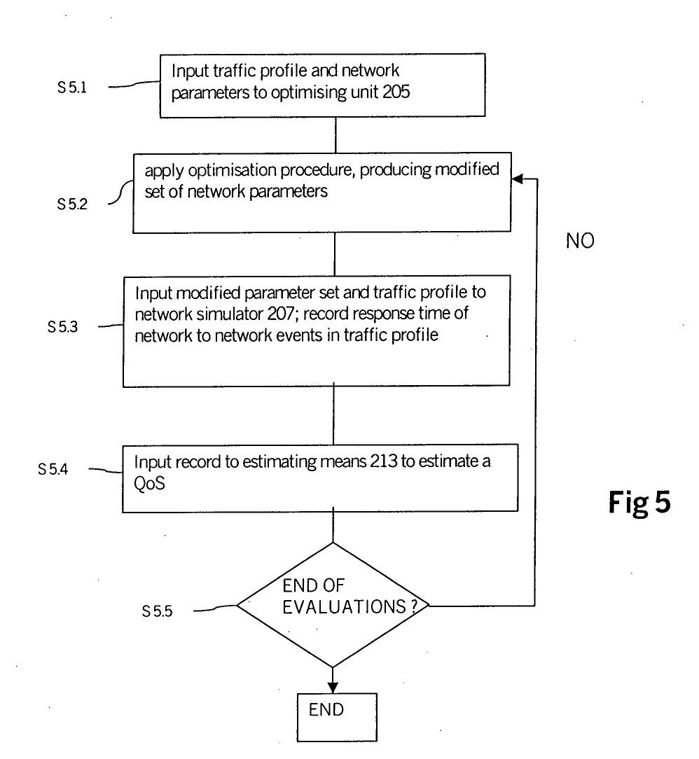

FIG. 5 is a flow diagram showing steps for evaluating performance of the network simulator of FIG. 2;

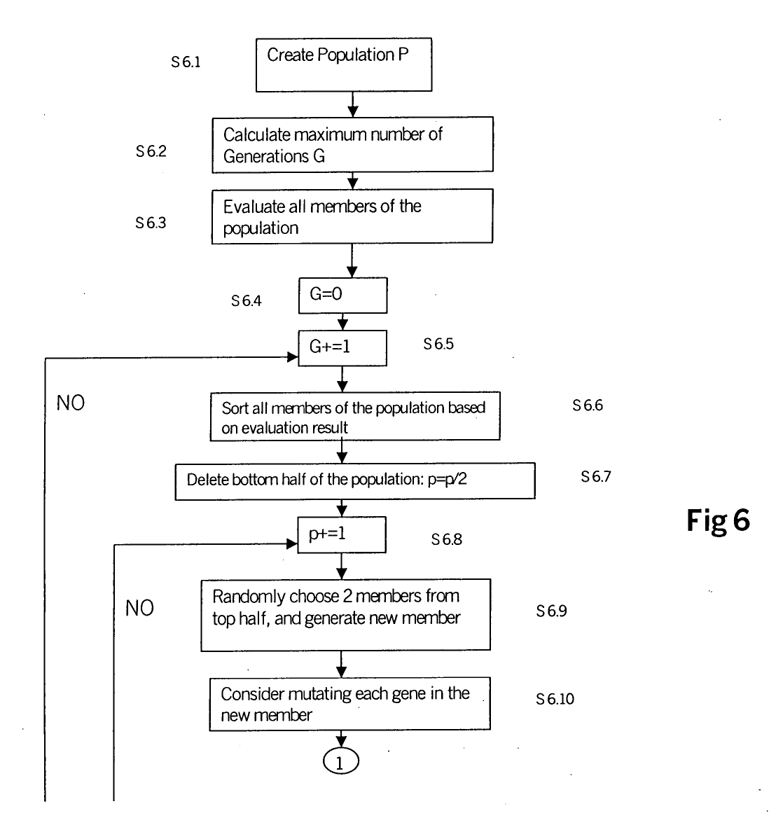

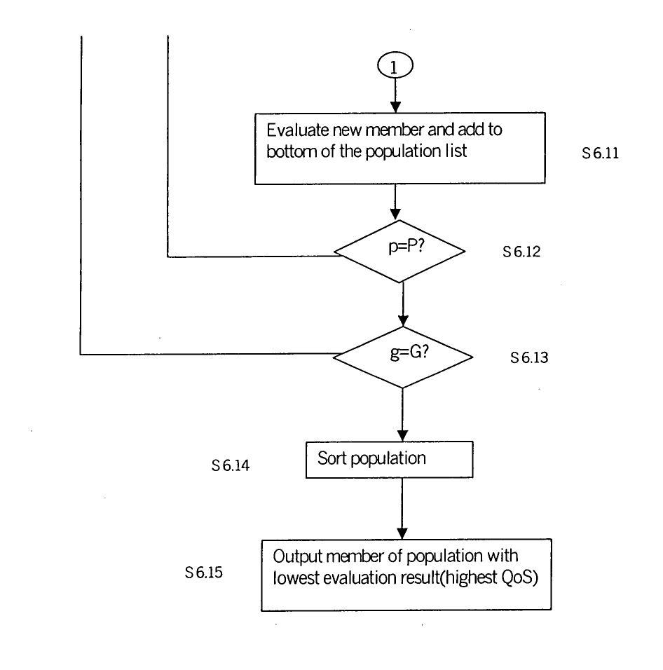

FIG. 6 is a flow diagram showing a Generational Breeder genetic algorithm for determining optimised network parameters;

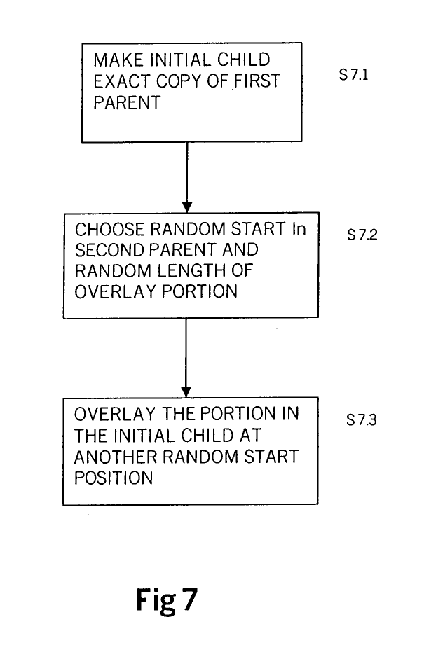

FIG. 7 is a flow diagram of the steps for generating a new solution vector in accordance with an embodiment of the present invention; and

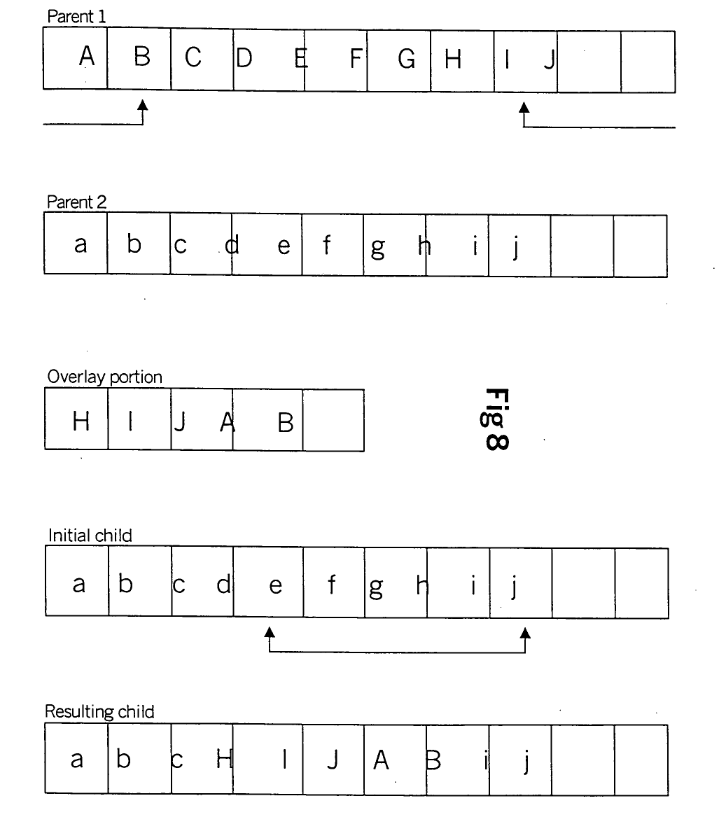

FIG. 8 is a schematic illustration of the process for generating a new solution vector in accordance with the flow diagram of FIG. 7.

In the following description, the terms “node” and “pipe” are used. These are defined as follows:

“node”: represents a device that is capable of switching, sinking and/or sourcing network traffic;

“pipe”: represents a medium over which network traffic is transmitted—for example fibre optic cable.

Overview

It is generally recognised that it would be useful to take account of customer requirements in the design and/or configuration of a network. However, at present there are no known methods that satisfactorily attempt to capture customer feedback and quantify it in such a way that it can be factored into network configuration. This is primarily because, although it is recognised that such a combination would be useful, identifying how to integrate customer feedback in such a way is not trivial.

Embodiments of the invention are concerned with providing a method and apparatus for varying network configuration, evaluating customer feedback in respect of each of the configurations, and changing both the network configuration and loading on a network in accordance with the feedback.

In particular, embodiments investigate the sensitivity of customer response to network performance. In one embodiment, customers subscribe to two different networks, each of which provides a quantifiable level of service. The configuration of a first of the networks can be modified, while the configuration of a second network remains static. Initially, both networks are subject to the same traffic conditions, and both output a level of service for the traffic conditions. Customer response to these levels of service is evaluated and used to modify the traffic profiles—e.g. to modify the loadings on one of the networks. In addition, customer response can be used to further modify the configuration of the first network.

Embodiments of the invention can be applied to circuit switched or packet switched fixed or wireless networks. FIG. 1 shows a generally conventional arrangement of a circuit switched network 100, specifically a Synchronous Digital Hierarchy (SDH) type of network, comprising switches 103, hosts 101 and regenerators 105 (only one of each type of nodes has been labelled in FIG. 1 for clarity). In a conventional manner, the SDH network makes a link available to users by a path 104—in accordance with circuit switched methods—and the path 104 carries user bits between two access points 102a, 102b. The access points 102a, 102b may be attached to ATM switches, Internet routers or to telephone switches, and the user bits may encode conversations, video or audio signals or ATM cells.

Advantages of embodiments include an ability to measure customer reaction to various network configurations and loading patterns on a network. This allows, for example, a network provider to model a network running several network-optimising strategies and then evaluate customer reaction to the resulting network performance. This enables the operator to assess the benefits of changing the real network configuration before investing in infrastructure or management to effect such changes.

Particularly advantageous features of the embodiments include an ability to evaluate both customer perception of network performance and customer sensitivity to changes in network performance. In addition, embodiments provide flexible mechanisms for modifying a network. For example a network can be optimised in accordance with a number of predetermined constraints, such as “minimise downtime”, “minimise cost” etc., and the events that the networks are subjected to can incorporate events such as link failure, link downtime etc.

FIG. 2 shows a block diagram of elements comprising an embodiment of the invention, generally referred to as engine 200. FIG. 3 shows a method for effecting operation of the engine 200.

The engine 200 includes, as inputs, one or more predetermined network traffic profiles 201, together with a list of network parameters 203, which control route and bandwidth allocation for network nodes. Each traffic profile comprises one or more network events, such as “set up call between node 1 and node 2 at 09:05”. The network parameters 203 include network routing and bandwidth variables and are described in greater detail below. In the following description a traffic profile is identified as 201_{—}_{^{i,j}} where i indicates an instance of a traffic profiles, and j indicates a network simulator that the i^{th} instance applies to. Network parameters are identified as 203_{—}_{ⁱ} where i indicates the i^{th} version of network parameters.

Essentially the engine 200 comprises first and second network simulators 207, 211, an optimiser 209, and an estimator 213. The estimator 213 determines respective Quality of Service (QoS) values for each of the network simulators 207, 211. In use, and referring to FIG. 3, elements of engine 200 inter-operate in the following manner: at step S 3.1 a first traffic profile 201_{—}_{^{1,207}} and a selected set of network parameters 203_{—}_{¹} are input to the network simulator 207 and optimiser 209. At step S 3.2 the network parameters 203_{—}_{¹} are optimised by the optimiser 209 for the first traffic profile 201_{—}_{^{1,207}}, in accordance with predetermined criteria as described in greater detail below, to generate optimised parameters 203_{—}_{²}.

At step S 3.3, the optimised parameters 203_{—}_{²} and a second traffic profile 201_{—}_{^{2,207}}, which is distinct from the first traffic profile 201_{—}_{^{1,207}}, are input to the first network simulator 207. The first network simulator 207 simulates network behaviour for the traffic events listed in the second traffic profile 201_{—}_{²²⁰⁷}. At step S 3.4, the second network simulator 211 receives input from both the second traffic profile 201_{—}_{²²¹¹} (which at this point can be identical to 201_{—}_{²²⁰⁷}) and the selected set of network parameters 203_{—}_{¹}.

A record is maintained of each network simulator's response to the network events comprising the second traffic profile 201_{—}_{^{2,207}} (e.g. in respect of events such as a failed link between nodes 1 and 2, the record details time taken to work out an alternative route for traffic between these nodes). At step S 3.5 these records are input to the estimator 213, which determines Quality of Service (QoS) values for each of the network simulators 207, 211.

At step S 3.6 the estimator 213 combines the respective QoS values with customer profiles (described in detail below) in order to generate a “measure of customer satisfaction” for one or more customer types.

At step S 3.7, modified traffic profiles 201_{—}_{^{3,207}}, 201_{—}_{^{3,211}} are generated for each of the network simulators 207, 211 respectively. The modification is dependent on the respective “customer satisfaction”, so that the modified traffic profile in respect of the first network simulator 201_{—}_{^{3,207}} is likely to be different to that of the second network simulator 201_{—}_{^{3,211}}. These modified traffic profiles 201_{—}_{^{3,207}}, 201_{—}_{^{3,211}} are subsequently input to their respective network simulators 207, 211, as shown in FIG. 3, which means that one of the networks will be more heavily loaded than the other network for the next simulation.

Before the network simulators 207, 211 operate under the conditions specified in the modified traffic profiles 201_{—}_{^{3,207}},201_{—}_{^{3,211}}, the optimiser 209 receives as input the second traffic profile 201_{—}_{^{2,207}}, and performs optimisation for this second traffic profile 201_{—}_{^{2,207}} as described above. Thus, when the first network simulator 207 operates on its modified traffic profile 201_{—}_{^{3,207}}, it applies an updated set of optimised network parameters 203_{—}_{³}.

This process is repeatable for any number of iterations (i).

Network Simulators & Network Parameters

FIG. 4 shows a simulation of a typical network arrangement. The simulated network has nodes 1-12 and pipes 403 (only one is labelled for clarity) to carry data between the nodes 1-12. The capacity of the pipes 403 is indicated by thickness of lines extending between the nodes 401—for example between node 2 and node 7, the line is thick, which indicates a (relatively) high communications capacity pipe 403a. In FIG. 4, node 12 is partially shaded, indicating that this node 12 has failed. As a result, links with neighbouring nodes 3, 8 and 11 are broken (indicated by the broken lines). Both network simulators 207, 211 can represent networks in this way.

Consistent with present physical switch and transmission systems, such as Asynchronous Transfer Mode (ATM) switches over a Synchronous Digital Hierarchy (SDH) transport layer, the maximum bandwidth of all of the pipes 403 exceeds the maximum switching capacity of corresponding nodes 1-12 at either end of the pipes. The nodes 1-12 communicate with each other via a seven-message command set (request locate destination, request alternative path, destination located, stop circuit, connection lost, synchronise a new link, request a new link) which travels along the pipes via a “management overhead” channel. All of the messages are time-stamped and are processed when received by a node in order of arrival; for messages that simultaneously arrive at a node from two or more different nodes, an arbitrary ordering is applied.

In operation, each node 1, . . . , 12 executes two distributed algorithms: a first for route finding and circuit establishment, and a second for dynamic bandwidth allocation. As described above, the pipes are capable of carrying far more traffic than an individual node can either switch, sink or source; therefore each node has to control allocation of pipe switching resource. When there is minimal network traffic, the allocation is likely to be evenly split between the pipes connected to the node, subject to the ability, or otherwise, of the node at the other end of the respective pipes to allocate an equivalent amount of switching resource. As the network becomes more heavily loaded, the nodes are operable to review the balance between pipes and to modify the distribution of switching capacity in order to accommodate uneven loading levels. Any change to the allocation of node switching capacity is negotiated between nodes at either ends of the loaded pipe, incurring a “synchronisation delay”.

The two algorithms are controlled by twelve parameters which affect how frequently they are run, how far they broadcast their connection request messages, how they handle time-outs and retries etc. The values of these parameters, together with traffic conditions, affects the ability of the network simulators 207, 211 to perform fast circuit set up and restoration (after simulated node or link failure). Clearly no single set of values gives optimum network performance under all conditions.

These parameters include the following:

Initial range of broadcast;

Number of retries on initial connect request;

Range extension multiplier (following failure, extend range by this factor);

Range minimum extension;

Retry timeout multiplier;

Number of retries on reconnection request (try more reconnects than initial connects because customer more sensitive);

Broadcast or selective message distribution percentage (type of message distribution);

Sequential or random message distribution;

Time between adaption cycles;

Time to synchronise new links;

Limit of free links if below node capacity;

Limit of free links if node at capacity.

This is a non-exhaustive list of parameters that affect network performance.

Optimiser & Traffic Profiles

A traffic profile 201_{—}_{^{i,j}} includes discrete network events, such as:

set up circuit between node 1 and node 2 at 09:05;

drop circuit between node 2 and node 7 at 09:07;

fail node 8 at 09:15;

repair node 12 at 09:22 etc.

(nodes 1, 2 and 7 can be seen in FIG. 4).

Within each iteration, i, the optimiser 209 includes means to adapt the network parameters 203 so as to generate a plurality of sets of network parameters, each of which sets modifies the distribution of network events (in the traffic profile 201_{—}_{^{i,j}}) in the network. For each set of network parameters (i.e. each modification of the network simulator 207), the optimiser 209 monitors the performance of the network simulator 207 against a predetermined performance measure—e.g. minimise connection time—in order to identify a set of network parameters that best satisfies the performance measure. This identified set of network parameters is assigned to network parameters for that iteration, i. In one embodiment the means to adapt the network parameters includes a genetic algorithm (GA), which performs population based adaption of the parameters.

FIG. 5 shows a process for adapting the network parameters for a generic traffic profile.

At step S 5.1 the optimiser 209 receives a traffic profile 203_{—}_{ⁱ} and network parameters, whereupon the network parameters are input to the GA. At step S 5.2 the GA applies an optimisation procedure, producing a modified set of network parameters (see below). At step S 5.3, the modified parameter set is then input to the network simulator 207, together with the traffic profile 203_{—}_{ⁱ} by the optimiser 209, and an associated time to set up circuits, restore circuits and repair nodes is recorded.

At step S 5.4, this record is sent to estimator 213, which combines these times in order to generate a corresponding QoS. QoS is a response value that quantifies the efficiency of the network to respond to the network events. In the simplest case, QoS may be a single dimensional performance measure, and measured by time to restore failed circuits. Preferably, QoS is a multi-dimensional performance measure, accounting for time to set up and drop down call requests as well as time to restore failed circuits. Ideally, therefore, QoS accounts for the response of the network simulators to every network event comprising the traffic profile.

At step S 5.5 the GA is run again in an attempt to optimise this value. In fact the optimisation process is repeated for a predetermined number of evaluations, and whichever parameter set outputs the highest QoS (thus lowest circuit restoration time) is assigned to optimised network parameters.

A GA algorithm for determining the optimum QoS for the traffic profile listed above is described with reference to FIG. 6. This flow diagram illustrates the steps of a Breeder genetic algorithm (for more information refer to H Müchlenbein and D Schlierkamp-Voosen (1994), The Science of Breeding and its application to the Breeder Genetic Algorithm, Evolutionary Computation 1, pp. 335-360.). In step S 6.1 an initial random population P (10) is created using a non-binary representation. Each gene position corresponds to a network parameter, and an allele is a specific instance of the parameter value. The genes comprise a mixture of real and integer-valued alleles (because of the nature of the network parameters). As a result of the mismatch of parameter types, all allele ranges are preferably normalised to the same range of values and then, for each type of gene, mapped according to predetermined ‘mapping’ functions in order to generate values that can be used in the first network simulator 207. This is generally known to those in the field of optimisation techniques as aligning allelic representations.

The maximum number of generations G to be allowed is calculated in step S 6.2 from the following equation:

G=5000/((population size/2)+1) (1)

In step S 6.3 all members of the population are then evaluated (see steps S 5.3, 5.4). In step S 6.4 g (current number of generations) is set to 0. In step S 6.5 the current generation number g is incremented by 1 and a loop in the algorithm is entered. All of the numbers of the population are sorted in step S 6.6 based on the evaluation result such that the lowest result is sorted to the top i.e. is the best. The bottom half of the population is then deleted in step S 6.7 and thus the current population p is set to equal half of the total population P. In step S 6.8 the current population p is incremented by 1 and in step S 6.9 two members from the top half of the population are chosen at random and a new member is generated using the technique which will be described hereinafter with reference to FIGS. 7 and 8.

In step S 6.10, using uniformly distributed allele replacement, each gene is mutated in the new member with a predetermined percentage chance of mutation. In step S 6.11, the new member is evaluated (see steps S 5.3, 5.4) and this is added to the bottom of the population list. In step S 6.12 it is then determined whether the original population size had been restored i.e. p=P and if not the process returns to step S 6.8. If the original population size P has been restored the process proceeds to step S 6.13 whereupon it is determined whether the maximum number of generations G has been reached i.e. g=G. If g is not equal to G the process returns to step S 6.5. If g=G the process proceeds to step S 6.14 where all the members of the population are sorted based on the evaluation results from the lowest result and best. In step S 6.15 the member of the population with the lowest evaluation result is entered. This can then be used for determining the values of the parameters.

Although in the genetic algorithms described above 5000 evaluations are used, any suitable number can be used. Mutation rate and population size can be appropriately selected to tune the genetic algorithm. For example the mutation rate of 14% can be chosen and the population size of anything from 5 to 500.

The method of generating the new member for the Breeder algorithm is described with reference to FIGS. 7 and 8. Using the two parents, in step S 7.1 an initial child is generated as an exact copy of parent 2. A portion of parent 1 of random length and at a random position is then selected in step S 7.2 i.e. length=5 and position=8 in this example, on FIG. 8. This overlay portion is then overlaid onto a portion of the initial child of the same length at another random position in step S 7.3 (i.e. at position=4 in this example) to generate the resulting child as illustrated in FIG. 8.

This technique is a variant of a two-point crossover technique that causes skewing. In this technique allele values in the child are directly overwritten by the overlay portion. There is no splicing and shunting of the genes.

Estimator 213

As described above, estimator 213 receives as input records of responses to network events from network simulators, including recorded times for restoring circuits, and total number of circuits successfully set up etc. From these values, the estimator 213 can estimate a QoS (as described above).

The network simulators 207, 211 are likely to represent different network operators, having different and characterisable advertising, pricing and marketing strategies. When the estimator 213 generates a “customer satisfaction” measure, this is estimated on the basis of a predetermined customer profile. Thus a customer profile represents customer tolerance with respect to faults, pricing structures, perception of operator behaviour and sensitivity thereto. It is therefore likely that different types of customers (different customer profiles) will have different tolerance responses to different levels of QoS. Furthermore, the customer profile will account for a customer's sensitivity to marketing and advertising mechanisms. A typical customer profile includes threshold-based migration through a simulated day, where the threshold quantifies tolerance levels to poor network performance as well as reaction to marketing initiatives etc.

When the estimator 213 interacts with the outputs from the network simulators 207 and 211, step S 3.7 in FIG. 3, the estimator 213 uses the estimated QoS, together with customer profile and the afore-mentioned network operator characteristics, in order to determine a measure of “customer satisfaction”. This measure is then used to derive new traffic profiles. If the customer satisfaction levels are higher for one of the network simulators in comparison to the other network simulator, the new traffic profile corresponding to the former will include more network events than the latter. This therefore represents a difference in customer loading, or a migration of customers from one network to another.

Implementation:

The network simulators 207, 211 are written using the Visual Basic programming language, and the estimator 213 is written using the proprietary IThink™ modelling tool. The simulator can be run in single step or continuous mode, either responding to user-generated events in real time, or processing pre-recorded event files. The simulator can also be remotely controlled via a script, or the like, for automatically running networks, event and parameter files, and for outputting performance figures.

The engine 200 can either be run on a single PC, running Windows™ 95 or Windows™ NT, or the network simulators and optimiser 207, 211, 209 may be run on a PC remote from the estimator 213. There is a control application, such as a script or the like, which manages the interaction described in FIG. 3.

Modifications:

The embodiment presented above includes two competing networks (specifically competing for customers), as a means to show the performance difference between a network that has had its parameters optimised, and a network that has not had its parameters optimised. An alternative embodiment could include only the optimiser 209 and first network simulator 207 (thus no second network 211). Such an arrangement of the engine 200 may be useful in fault-finding situations, where the network is experiencing a particular type of failure. By generating a range of populations (either explicitly or by generating a new member as described with reference to FIG. 7), and observing the behaviour of the simulated network, it may be possible to identify parameter(s) that are correlated with the network behaviour. In this situation, the genetic algorithm is used to generate a range of network operating conditions (or a range of network parameters), with no specific interest in finding an optimum.

A further embodiment could include three or more competing networks, where two of the networks are optimised in accordance with two different criteria—e.g. first network could be optimised in accordance with minimising downtime, the second network could be optimised in accordance with network operating costs, while the third network could remain static. Any number of permutations along these lines—involving optimisation criteria and a plurality of networks—could be envisaged within the scope of the invention.

Furthermore, if the engine 200 is to be used purely for determining optimum network parameters for a predetermined traffic profile, then the second network is not required 211 (i.e. ignoring effects of customer feedback). For example network operators may be forced to operate their networks at a predetermined QoS level. This scenario does not interact with, or depend upon, a second network, so an embodiment of the engine 200 could similarly exclude the second network simulator 211 (and traffic profiles associated therewith).

At present the traffic profiles represent network events that occur over a whole day: a previous day's profile is used to optimise parameters and these optimised parameters, together with the next day's traffic profile are input to the network simulator. Thus optimum network parameters for the previous day's profile determine the network response to the next day's network events. In situations where traffic patterns are largely unchanged from day-to-day, this is acceptable, but where the patterns are different (for example Sunday compared to Monday), the network parameters could be expected to cause the network to under-perform. As an alternative, generic day profiles could be generated and used for the optimisation. For example:

Determine an average profile for each day of the week using a plurality of traffic profiles gathered over many weeks;

Run optimisation for average Monday (instead of instance of Sunday, as described in FIG. 3);

Apply optimised parameters to instance of Monday (unseen traffic profile);

Modify Monday average, taking account of instance.

In the above embodiment the traffic profiles include network events that occur over a 24-hour period. Thus the network parameters are optimised for many variable events that occur during that period. It is therefore arguable that this represents an optimised compromise. This could be improved by characterising network events during certain periods of the day—thus for a day having several traffic profiles, each characterising network events at different times of the day. The above embodiment could then be operated over each of these traffic profiles for each day, rather than over a single profile for each day. This modification would be particularly useful for networks that experience large variations in network traffic over a single day. As described above, usually network algorithms are detuned in order to cope with (often short) periods of high loading, and the algorithms, in this detuned state, control the performance of a network over a whole day. This results in the network running sub-optimally for the majority of its working period.

As described above, the QoS is quantified by call set up times, call restoration times for broken circuits etc. However, if data relating to the network characteristics were available, such as bit error rates, packet loss, jitter and latency, the QoS could additionally account for these features of the network.

Although the above embodiment describes operation of embodiments of the invention for a circuit switched network, the invention could also be used to monitor and improve performance for a packet switched network, such as an Internet Protocol network, where network traffic, node capacity, routing mechanisms, network algorithms, network hardware performance etc all affect delivery of IP packets. For example, given a particular load on a network, localised bottlenecks, where nodes are working at maximum capacity, can arise, and affect transmission of data. Furthermore, when network elements fail, packets are routed via a different path, and the associated re-routing may introduce jitter and latency into packet delivery. Typical examples of applications using packet switched networks include Internet chat, accessing of data from storage devices and/or databases, voice over IP, transmission of video etc.

The GA described above is merely an example of a suitable type of algorithm; a single three way Tournament genetic algorithm could similarly be used (for more information see Tournament GA ref is D E Goldberg and K Deb (1991), A comparative analysis of selection schemes used in genetic algorithms, in Foundations of Genetic Algorithms, ed G Rawlins (San Mateo, Calif.: Morgan Kaufmann) pp 69-93). Although in the optimisation method described above 5000 evaluations are used, any suitable number can be used. Mutation rate and population size can be appropriately selected to tune the genetic algorithm. For example the mutation rate of 14% can be chosen and the population size of anything from 5 to 500. Furthermore, optimisers such as local search hillclimber, simulated annealer may be used instead of a GA.

As will be understood by those skilled in the art, the invention described above may be embodied in one or more computer programs. These programs can be contained on various transmission and/or storage mediums such as a floppy disc, CD-ROM, or magnetic tape so that the programs can be loaded onto one or more general purpose computers or could be downloaded over a computer network using a suitable transmission medium.

1. A network simulation method comprising the steps of:
(i) creating simulated first and second networks, each simulated network comprising data indicative of a plurality of network nodes and network links therebetween and being operable to process one or more simulated network events in accordance with a plurality of network algorithms, each network algorithm being characterised by a plurality of simulated network parameters;
(ii) modifying a group of one or more simulated network parameters;
(iii) applying the group of modified simulated network parameters to said network algorithms for the first simulated network, and causing the first simulated network to process the one or more simulated network evtents;
(iv) applying a group of one or more unmodified simulated network parameters to said network algorithms for the second simulated network, and causing the second simulated network to process said one or more simulated network events;
(v) for the first and second simulated networks, evaluating the success or otherwise of the respective simulated network to process the or each simulated network event, and quantifying the same as first and second performance values;
(vi) comparing the first and second quantified performance values with a predetermined performance value and identifying which of the first or second quantified performance values most closely resembles the predetermined performance value; characterised in that for each simulated network, step (v) involves for the or each processed simulated network event:
identifying a type of simulated customer involved in the processed simulated network event;
selecting a customer profile relating to the identified simulated customer type;
receiving data indicative of the success, or otherwise, of the simulated network to process the simulated event;
identifying, on the basis of the selected customer profile and the received data, a performance figure, and
combining the identified performance figures from all of the processed simulated network events to yield a combined performance value;
and by, in response to receipt of a plurality of other simulated network events, assigning more of the plurality of other simulated network events to the simulated network corresponding to the identified performance value than to the other simulated network, thereby adapting distribution of simulated network events between the two simulated networks.

2. A method according to claim 1, in which the customer profile includes data identifying customer expectations of any one, or all, of quality of service, network charging rates and network downtime.

3. A method according to claim 2, in which the data in the customer profile varies as a function of time of day, so that the step of identifying a performance figure on the basis of the selected customer profile and the received data involves retrieving data from the customer profile corresponding to the time at which the simulated network event was processed.

4. A method according to any one of the preceding claims, in which step (ii) involves
obtaining a plurality of initial strings of values to form a population, the initial strings of values representing values of a group of one or more simulated network parameters;
applying a genetic algorithm to the population so as to generate modified simulated parameter values;
inputting the modified parameter values to the network algorithms;
inputting one or more simulated network events to a simulated network;
evaluating the success or otherwise of the simulated network to process the or each simulated network event, and quantifying the same as a first performance value;
repeating the applying, inputting and evaluating steps at least twice and identifying which of the first performance values most closely resembles a predetermined response value, the modified parameters corresponding thereto being those applied to the network algorithms at step (ii).

5. A computer program, or a suite of computer programs, comprising a set of instructions to cause a computer, or a suite of computers, to perform the method according to claims 1 to 4.

6. Network simulation apparatus including
first and second simulated networks, each simulated network comprising data indicative of a plurality of network nodes and network links therebetween and being operable to process one or more simulated network events in accordance with a plurality of network algorithms, wherein each network algorithm is characterised by a plurality of simulated network parameters;
modifying means arranged to modify a group of one or more simulated network parameters;
means arranged to input the group of modified simulated network parameters to the first simulated network and to input a group of unmodified simulated parameters to the second simulated network;
evaluating means arranged to evaluate the success or otherwise of the respective simulated network to process the or each simulated network event, and to quantify the same as first and second performance values;
comparing means arranged to compare the first and second quantified performance values with a predetermined performance value and to identify which of the first and second quantified performance values most closely resembles the predetermined performance value; characterised in that for the or each processed simulated network event, the evaluating means is arranged to:
identify a type of simulated customer involved in the processed simulated network event;
select a customer profile relating to the identified simulated customer type;
receive data indicative of the success, or otherwise, of the simulated network to process the simulated event;
identify, on the basis of the selected customer profile and the received data, a performance figure, and
combine the identified performance figures from all of the processed simulated network events to yield a combined performance value;
and in that the apparatus includes
assigning means arranged, in response to receipt of a plurality of other simulated network events, to assign more of the plurality of other simulated network events to the simulated network corresponding to the identified performance value than to the other simulated network, thereby adapting distribution of simulated network events between the two simulated networks.

7. Apparatus according to claim 6, in which the customner profile includes data identifying customer expectations of any one, or all, of quality of service, network charging rates and network downtime.

8. Apparatus according to claim 7, in which the data in the customer profile varies with time of day.

9. Apparatus according to any one of claims 6 to 8, including means arranged to create the first and second simulated networks.

10. Apparatus according to any one of claims 6 to 9, wherein the modifying means is operable to
receive a plurality of initial strings of values to form a population, the initial strings of values representing values of a group of one or more simulated network parameters; and
apply a genetic algorithm to the population so as to generate modified simulated parameter values.

11. Apparatus according to any one of claims 9 to 10, including at least a third simulated network.

12. Apparatus according to claim 11, wherein the modifyinig means is arranged to generate at least a second group of one or more modified network parameters, the said second group of network parameters being input to the third simulated network, and wherein the evaluating means (iii) is arranged evaluate the success or otherwise of the third simulated network to process the or each simulated network event, and to quantify the same as third performance value, which third customer value is used by the assigning means to modify the allocation of network events in respect of the first, second and third simulated networks.
